(19) United States
(12) Patent Application Publication
(10) Pub. No.: US 2006/0183558 A1
(43) Pub. Date: Aug. 17, 2006

(54) Driveshaft coupling

(75) Inventor: Robert Stuart Feldmann, Londonderry, NH (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership

(21) Appl. No.: 11/058,833

(22) Filed: Feb. 16, 2005

(51) Int. Cl. F16L 25/00

(52) U.S. Cl. 464/93

(57) ABSTRACT

A flexible driveline coupling is provided for interconnecting two rotational elements and includes an insert including a plurality of spaced mount portions that is overmolded with a second material such as microcellular urethane that provides improved torsional vibration isolation as well as reduced peak loads transmitted between the rotational elements. In addition, the design provides for reduced mass, reduced cost, and reduced noise transmission.

### FIELD OF THE INVENTION

The present invention relates to drive line couplings and more particularly to a flexible drive line coupling.

### BACKGROUND OF THE INVENTION

Flexible driveline couplings have been used in many applications including automotive, appliance, construction equipment, manufacturing equipment, and other industrial applications where it is desirable to interconnect two rotational elements while dampening vibration, isolating peak torque inputs, and reducing peak loads.

It is desirable in the art to provide a flexible coupling with reduced mass, reduced cost, improved torsional vibration isolation, reduced peak loads, and reduced noise.

### SUMMARY OF THE INVENTION

Accordingly, the present invention provides a device for interconnecting two rotational elements comprising an insert including a plurality of spaced mount portions, each of the spaced mount portions being adapted to attach to one of two rotational members. The insert is made of a first material that is generally rigid, yet flexible, such as, for example, plastics, including glass filled nylon, steel, and other materials. A second material is molded between the plurality of spaced mount portions and is preferably a compressible material such as, for example, microcellular urethane, although other materials may also be utilized. The compressible material can have a linear or non-linear spring rate under compression, depending on the specific application.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-sectional view of a driveshaft coupling for connecting first and second rotary members according to the principles of the present invention;

FIG. 2 is a plan view of the flexible driveshaft coupling according to the principles of the present invention with the overmolded insert being shown in phantom;

FIG. 3 is a plan view of the insert utilized in the flexible driveline coupling according to the principles of the present invention;

FIG. 4 is a cross-sectional view taken along line 4-4 of FIG. 3;

FIG. 5 is a plan view of a second embodiment of the insert according to the principles of the present invention;

FIG. 6 is a cross-sectional view taken along line 6-6 of FIG. 5; and

FIG. 7 is a detailed view showing an alternative embodiment of the fingers of the driveshaft coupling according to the principles of the present invention.

### DETAILED DESCRIPTION OF THE PREFERRED EMBODIMENTS

The following description of the preferred embodiment(s) is merely exemplary in nature and is in no way intended to limit the invention, its application, or uses.

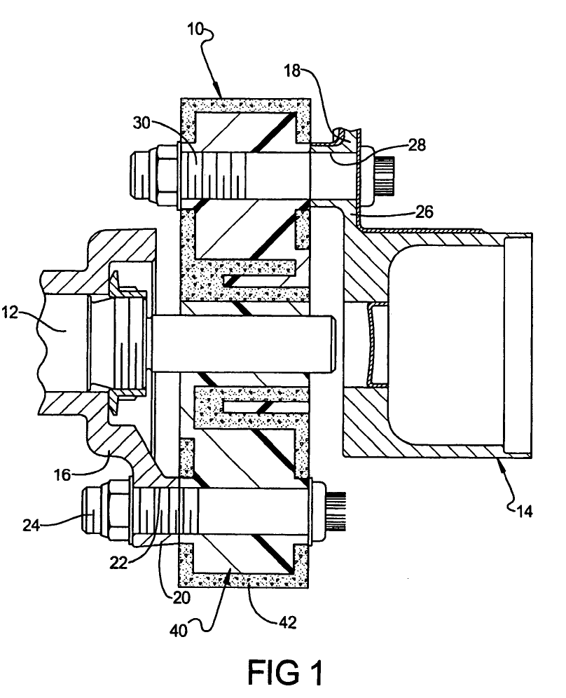

With reference to FIGS. 1-4, a flexible driveline coupling 10, according to the principles of the present invention, will now be described. The driveline coupling 10 is provided for interconnecting a first rotatable member 12 and a second rotatable member 14 each of which is provided with an attachment yoke 16, 18, respectively. The first yoke 16 includes a plurality of arms 20 (only one of which is shown) and which each include an aperture 22 for receiving a first set of fasteners 24. The yoke 18 also includes a plurality of arms 26 provided with apertures 28 for receiving a second set of fasteners 30. Although the first and second rotatable members 12, 14 and yokes 16, 18 are shown for illustrative purposes, it should be understood that the flexible driveline coupling can be used with other yoke designs.

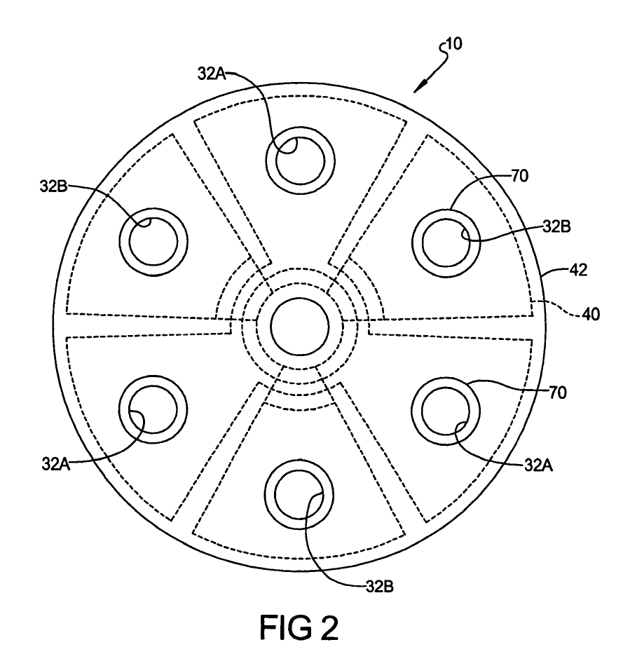

As shown in FIG. 2, the flexible coupling 10 includes six apertures, 32A, 32B. Three apertures 32A are provided for receiving the threaded fasteners 24 for connecting to the first yoke 16 and three apertures 32B are provided for receiving fasteners 30 for connection to the second yoke 18. As seen in FIG. 2, the apertures 32A are alternately disposed between apertures 32B.

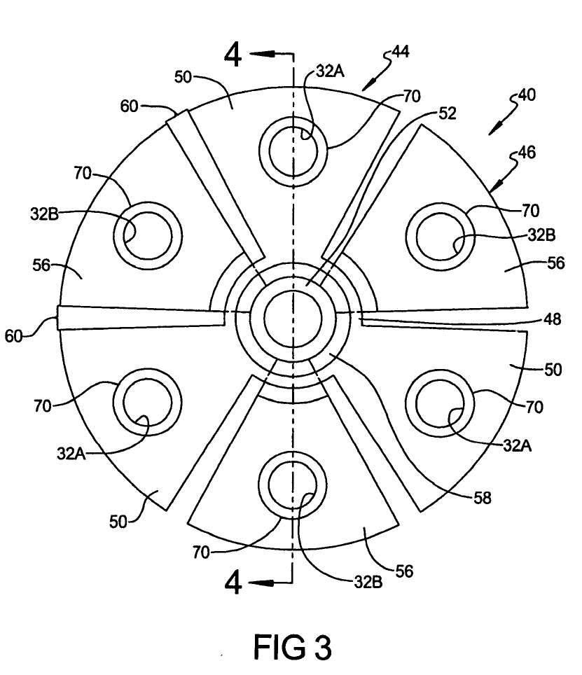

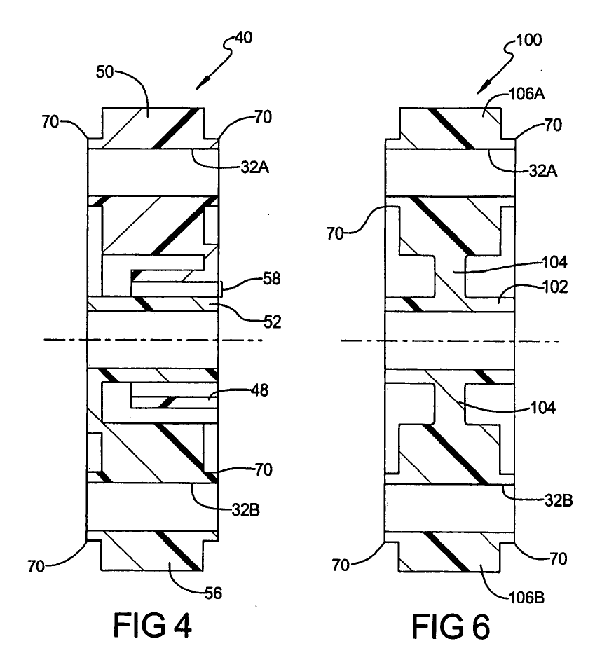

The flexible driveline coupling 10 includes an insert 40 that is made of a first material and which is overmolded by a second material 42. The insert 40 as illustrated in FIGS. 3 and 4 includes a first insert member 44 and a second insert member 46 with the first insert member including a central ring-shaped hub portion 48 and a plurality of radially extending mounting portions 50 each provided with an aperture 32A extending therethrough. The second insert member 46 also includes a ring-shaped central hub portion 52 with a plurality of radially extending mount portions 56 extending outwardly therefrom.

According to one embodiment, the central hub portions 48, 52 of the first and second insert members 44, 46 are concentric with one another with the central hub portion 52 of the second insert member 46 being received within the central hub portion 48 of the first insert member 44. A space or gap 58 can be provided between the central hub portions 48, 52, as desired, or if desired, no gap can be provided therebetween in order to provide a closer fit between the first and second insert members 44, 46.

The mount portions 50 of the first insert member 44 and the mount portions 56 of the second insert member 46 are alternately disposed between one another with a space 60 being provided between each adjacent mount portions 50 and 56. The spaces 60 can be provided such that each space 60 is equivalent in dimension, or alternatively, the spaces can be specifically designed to provide different dynamic or functional or performance characteristics depending on the rotational direction of the rotary members 12, 14.

The first and second insert members 44, 46 are overmolded with the second material 42 as illustrated in FIG. 2 such that the second material is provided in the spaces 60 between the mount portions 50, 56 of the first and second insert members 44, 46. The second material 42 is preferably a compressible material having a non-linear spring rate such as microcellular urethane, although is should be understood that other flexible and compressible materials may also be utilized. The material of the insert 40 can include plastic materials which are generally rigid yet flexible, such as glass-filled nylon, while other materials, such as other plastics and metals that exhibit similar characteristics could also be utilized. The microcellular urethane material provided in the spaces 60 between the mount portions 50, 56 allow for improved torsional vibration isolation and reduced peak loads transferred between the first and second rotational elements 12, 14.

The flexible driveline coupling 10 also provides for reduced mass, reduced cost, and reduced noise as compared with current flexible coupling designs. The overmolded microcellular urethane material provides for a quiet and low mass interconnection between the first and second insert members 44, 46. The coupling 10 of the present invention also accommodates for “coning angle” or angular misalignment of the first and second rotatable members 12, 14 while providing rotary interconnection therebetween. The coupling 10 also accommodates axial misalignment/axial movement of one rotatable member 12, 14 relative to the other. The insert members can be provided with raised shoulder portions 70 provided around the apertures 32A, 32B in order to allow the fasteners 24, 30 and yokes 16, 18 to engage the raised shoulder portions 70 so that no metal sleeves or torsion limiters are required. It should be understood, however, that torsion limiting sleeves can also be utilized in combination with the flexible driveline coupling of the present invention.

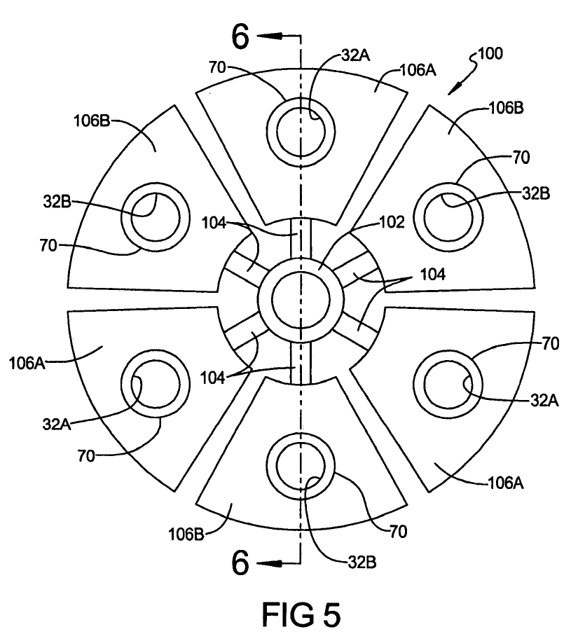

With reference to FIGS. 5 and 6, an alternative insert 100 for use in the flexible driveline coupling of the present invention will now be described. The insert 100 is formed as a unitary member including a central hub portion 102, a plurality of integrally formed spokes 104 and a plurality of spaced mount portions 106A, 106B. The insert 100 is overmolded by a second material 42, such as the microcellular urethane material as discussed above. Each alternating mount portion 106A of the insert 100 is provided with an aperture 32A for connection to first yoke 16 via fasteners 24 while every other mount portion 106B is provided with an aperture 32B for connection with second yoke 18 via fasteners 30. The interconnection of the spokes 104 to the central hub 102 maintain the first and second rotational elements 12, 14 in coaxial alignment while allowing the mount portions 106A, 106B to compress the microcellular urethane material therebetween in order to provide torsional vibration isolation and reduced peak loads delivered therebetween.

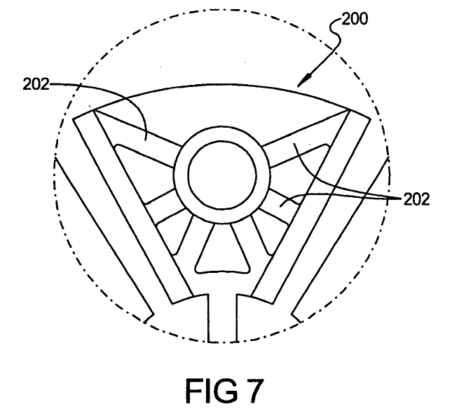

As a still further modification as illustrated in FIG. 7, the mount portions 50, 56; 106A, 106B can be provided with a latticed construction 200 including a plurality of cross-web portions 202 in order to reduce the amount of plastic material required without significantly affecting the structural integrity thereof. A latticed construction 200, as illustrated in FIG. 7, also can contribute toward reducing the mass of the overall flexible driveline coupling 10.

It should be understood that the materials used, the geometry of the mount portions and the spacing therebetween, can all be specifically designed to give preferred performance characteristics.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A device for interconnecting two rotational elements, comprising:
an insert including a plurality of spaced mount portions, each of said spaced mount portions being adapted to attach to one of said two rotational members, said insert being made of a first material; and
a second material molded between said plurality of spaced mount portions, said second material being a compressible material.

2. The device according to claim 1, wherein said first material is a plastic material.

3. The device according to claim 1, wherein said first material is glass filled nylon.

4. The device according to claim 1, wherein said second material is microcellular urethane.

5. The device according to claim 1, wherein said insert includes a first insert member and a second insert member each including a plurality of said mount portions, said mount portions of said first insert member being alternately disposed between said mount portions of said second insert member, said second material being overmolded over said first and second insert members.

6. The device according to claim 5, wherein said first and second insert members include a first and a second hub portion, respectively, wherein each of said plurality of mount portions extend radially outward from one of said first and second hub portions.

7. The device according to claim 1, wherein each of said plurality of mount portions extend radially outward from a central hub portion.

8. The device according to claim 1, wherein said first material is a flexible and relatively incompressible material.

9. A device for interconnecting two rotational elements, comprising:
a plastic insert including a plurality of spaced mount portions, each of said spaced mount portions being adapted to attach to one of said two rotational members; and
a microcellular urethane disposed between said plurality of spaced mount portions.

10. The device according to claim 9, wherein said plastic insert includes a first insert member and a second insert member each including a plurality of said mount portions, said mount portions of said first insert member being alternately disposed between said mount portions of said second insert member, said microcellular urethane being overmolded over said first and second insert members.

11. The device according to claim 9, wherein each of said spaced mount portions extend radially outward from a central hub portion.

12. The device according to claim 11, further comprising a spoke portion disposed between each of said spaced mount portions and said central hub portion.

13. The device according to claim 9, wherein adjacent spaces between said plurality of spaced mount portions have different dimensions.

14. A device for interconnecting two rotational elements, comprising:
an insert including a plurality of spaced mount portions, each of said spaced mount portions being adapted to attach to one of said two rotational members; and
a microcellular urethane disposed between said plurality of spaced mount portions.

15. The device according to claim 14, wherein said insert includes a first insert member and a second insert member each including a plurality of said mount portions, said mount portions of said first insert member being alternately disposed between said mount portions of said second insert member, said microcellular urethane being overmolded over said first and second insert members.

16. The device according to claim 14, wherein each of said spaced mount portions extend radially outward from a central hub portion.

17. The device according to claim 16, further comprising a spoke portion disposed between each of said spaced mount portions and said central hub portion.

18. The device according to claim 14, wherein adjacent spaces between said plurality of spaced mount portions have different dimensions.
